(19) United States
(12) Patent Application Publication
(10) Pub. No.: US 2026/0251060 A1
(43) Pub. Date: Aug. 27, 2026

(54) Surface-Powered Impedance-Modulated Telemetry System and Related Methods

(71) Applicant: RIME Downhole Technologies, LLC, Benbrook, TX (US)

(72) Inventor: Manoj Gopalan, Fort Worth, TX (US)

(73) Assignee: RIME Downhole Technologies, LLC, Benbrook, TX (US)

(21) Appl. No.: 19/546,225

(22) Filed: Feb. 20, 2026

Related U.S. Application Data
(60) Provisional application No. 63/761,832, filed on Feb. 21, 2025.

(51) Int. Cl. E21B 47/12; H04L 25/02

(52) U.S. Cl. CPC E21B 47/12; H04L 25/0278

(57) ABSTRACT

A surface-powered and impedance-modulated telemetry system permits data from downhole to be telemetered to the surface from within a borehole by using a surface power source to provide a known, controlled, value (V or I) of an electrical signal. The electrical signal completes an electrical circuit through some portion of the downhole components, a surface conductor, and the formation. The downhole components are in contact with the formation and include an impedance-variation system to controllably vary the impedance of those components to encode desired data using a switch system control the impedance of the electrical connection of the upper components to the lower components. At the surface, a measured value of the circuit value (I or V), which depends upon that varying impedance, is acquired. The data encoded in the varying impedance is decoded using that controlled value and the measured value to form a signal.

### FIELD OF THE INVENTION

In general, the present invention relates to a device, system or method including an transmitter system powered at the surface (such as one using electrical current or an electromagnetic (EM) field), an electrical measurement system for measuring voltage or current, and an electrically insulated downhole device used in the process of drilling a subterranean borehole for selectively, variably, and controllably electrically connecting the lower portion of the drill string to the upper portion of the drill string to cause the measured voltage or current to alternate between a high and a low signal for telemetering data from a downhole tool located near the sub to encode information and telemeter such information to the surface in real time.

### BACKGROUND OF THE INVENTION

In the drilling of deep bore holes, the rotary drilling technique has become a commonly accepted practice. This technique involves using a drill string which consists of numerous sections of hollow pipe connected together, to the bottom end of which a drill bit is attached. By imparting axial forces onto the drilling bit and by rotating the drill string, and thus the bit, either from the surface or using a hydraulic motor attached to the drill string, a reasonably smooth and circular bore hole is created. The rotation and compression of the drilling bit causes the formation being drilled to be crushed and pulverized. Drilling fluid is pumped down the hollow center of the drill string through nozzles on the drilling bit and then back to the surface around the annulus of the drill string. This fluid circulation is used to transport the cuttings from the bottom of the bore hole to the surface where they are filtered out and the drilling fluid is recirculated as desired. The flow of the drilling fluid also provides other secondary functions such as cooling and lubricating the drilling bit cutting surfaces and exerts a hydrostatic pressure against the borehole walls to help contain any entrapped gases or fluids that are encountered during the drilling process. To enable the drilling fluid to travel through the hollow center of the drill string, the restrictive nozzles in the drilling bit and to have sufficient momentum to carry cutting and debris back to the surface, the fluid circulation system at the surface includes a pump or multiple pumps capable of sustaining sufficiently high pressures and flow rates, piping, valves and swivel joints to connect the piping to the rotating drill string.

The need to measure certain parameters at the bottom of a bore hole and provide this information to the driller has long been recognized. These parameters include, but are not limited to the temperature, pressure, inclination and direction of the bore hole, vibration levels, inclination, azimuth, toolface (rotational orientation of the drill string), but also include various geophysical and lithological measurements and formation geophysical properties such as resistivity, porosity, permeability, and density as well as in-situ formation analysis for hydrocarbon content. The challenge of measuring these parameters in the hostile environment at the bottom of a borehole during the drilling process and conveying this information to the surface in a timely fashion has led to the development of many devices and practices.

It is an advantage to be able communicate data that comes from the bottom of a wellbore to the surface, while drilling, and without the use of wires or cables, and without the continuous and/or frequent interruption of drilling activity. Thus, downhole telemetry systems have been developed, including tools commonly referred to as “measurement while drilling” or “MWD” tools. Telemetering these parameters is also valuable for the interior of an existing bore, or within the interior of an existing pipe or other subterranean structure. In addition to use in a drill string, telemetering of such parameters is also valuable in other forms of downhole tools including an upstring device and a downstring device, such as in measurement devices for pipes or bores, that could be pushed (longitudinally rigid) or pulled or towed therethrough.

An MWD tool is commonly mounted to the inside of a drill pipe, and typically above but near to the lower end of the drill string, adjacent to, or nearly adjacent to, the bottom-hole assembly (BHA). The BHA includes the bit and may include other objects such as mud motors, stabilizers, drill collars.

A downhole telemetry system may transmit data in several ways, including: creating signals (low frequency radio waves or signals, or currents in the earth or magnetic fields) downhole to propagate said signals through the earth and receiving those signals at the surface using an antenna or other receiving apparatus; imparting high frequency vibrations to the drill string which can be used to encode and transmit data to the surface; and creating pressure pulses to encode and transmit data to the surface of the earth from the bottom of a borehole.

A well-known limitation of using transmission to transmit data from the bottom of a wellbore to the surface is the need to deliver sufficient power to enable the signals to reach the surface and to be subsequently detected. The presence of subterranean formations which are substantially electrically insulating requires that, in certain conditions, the downhole tool may need to transmit at a very high-power level to enable the signals to be detectable at the surface. In other situations, the use of highly conductive borehole fluids causes the signals to effectively short out at the downhole transmitter thus significantly reducing the strength of the signal detectable at the surface. As most MWD tools are powered by downhole batteries, it thus becomes prohibitively expensive and impractical to transmit the signals at sufficiently high-power levels to enable detection in all conditions.

Thus, there is a need for a telemetry system that can overcome these limitations and be able to provide reliable telemetry of data from a subsurface location to the surface.

### BRIEF STATEMENT OF THE INVENTION

A new and improved apparatus, system, and method of use are presented for a telemetry system for use in a downhole environment that provides asynchronous telemetry between the surface and a downhole position adjacent or nearly adjacent to a downhole tool, such as an MWD tool. The telemetry system transmits data by changing the impedance seen by a surface-located and surface-powered transmitter system resulting in detectable changes in a measured electrical characteristic, e.g. current or voltage of that system. A variable impedance telemetry system includes the ability to controllably vary, mechanically or electrically, the portion of the system impedance contributed by the components, and transmits an electrical signal into a downhole formation, completing an electrical circuit by the current passing through the formation between the portion (or portions) of the drill string electrically connected to the controlled power source and to the surface conductor. It is thus transmitting an electric signal through the formation. But a variable impedance telemetry system need not receive that electrical signal to telemeter data and that data telemetering process is carried out independently of receiving that electrical signal. Instead, that data telemetering process relies on detecting the changes in that measured electrical characteristic, e.g. current or voltage, of that system.

A telemetry system includes a constant power supply to supply constant voltage or constant current (or a controlled voltage/current such as for an AC signal), an electrical measurement device to measure either current or voltage, a surface conductor connecting the constant power supply to the ground at a second location spaced apart from the drill rig/drill string. The telemetry system also includes a selectively-electrically insulating gap sub, one providing a selectively controllable and variable electrical connection between an upper drill string portion and a lower drill string portion. This gap sub can be referred to as an impedance-variation sub (IVS) and may include an impedance switch controller (ISC) for controlling the electrical connection. The upper drill string portion (UDS), or uphole portion, may comprise drill pipes and optionally drilling collars and the lower drill string portion (LDS), or downhole portion, may comprise a lower collar section and a drill bit.

Here, the IVS is mechanically and electrically connected to the UDS at its upper end via an upper gap section and to the LDS at its lower end via a lower gap section. Between the upper gap section and lower gap section is an insulating gap section that includes a switch system with a switch, an insulating structure that mechanically connects the UDS to the LDS, and electrical connections between the switch system and the LDS and between the switch system and the UDS. Mechanically, the IVS connects the upper and lower gap sections via threaded connections (drill pipe connections) commonly used in drill pipe and downhole subs to the adjacent elements of the drill string. The upper and lower gap sections are each then connected electrically to the drill pipe via centralizers on those adjacent elements or other methods. The insulating gap section also supports the drill string forces between the upper and lower gap sections. Unlike a traditional gap sub, however, the IVS can both electrically isolate the UDS from the LDS and form an intentional, low-resistance electrical connection between the UDS and the LDS and form an intentionally variable-resistance electrical connection between the upper and lower gap sections and between the UDS and the LDS. That connection, moreover, is readily switchable from open to closed and varied by the switch system. That switch system operates to selectively connect the threaded connections at either end of the IVS and vary the electrical connection therebetween the ends of the switch as connected to the upper and lower gap sections. The switch system requires only low power and may be switched at frequencies in ranges that are selected and useful to the operator. In addition, the switch system can be electronically linked, for controlling its actions, to an MWD tool (e.g. a data-source), or other upstring or downstring device requiring data telemetry.

A switch controls the flow of current therethrough by acting as a resistor, and may be a semiconductor based device, such as a MOSFET, a variable resistor, a digital resistor, a magnetically activated relay, or a mechanical contact of any kind, with the goal being that when the tool or controller commands that the switch activate to either an open position or a closed position, between a low, intermediate, and high impedance positions, between a lowest, one or more intermediate, and highest impedance positions, between a lowest, lower, one or more intermediate, higher, and highest impedance positions, or along a range of impedance positions varying continuously or stepwise within or along a range. Impedance positions does not imply that the switch has components that change physical position but refers to its configuration that controls the switch's impedance.

A telemetry system includes a constant power supply to supply constant voltage or constant current (or a controlled voltage/current such as for an AC signal), an electrical measurement device to measure either current or voltage, a surface conductor connecting the constant power supply to the ground at a second location spaced apart from the drill rig/drill string, and an impedance-variation system with a selectively-electrically insulating gap sub, and an impedance switch system (ISS) providing a selectively controllable and variable electrical connection between an upper drill string portion and a lower drill string portion by electrically spanning the gap sub (though it need not mechanically span the gap sub). Here, the ISS includes a switch forming a selectively controllable and variable electrical connection between an upper drill string portion and a lower drill string portion (thus spanning the gap sub and permitting it to be selectively-electrically insulating) and an impedance switch controller (ISC) for controlling the ISS. The ISC controls which of the impedance positions the switch is placed in. This gap sub can be referred to as an impedance-variation sub (IVS). The upper drill string portion (UDS), or uphole portion, may comprise drill pipes and optionally drilling collars and the lower drill string portion (LDS), or downhole portion, may comprise a lower collar section and a drill bit.

The gap sub is mechanically and electrically connected to the UDS at its upper end via an upper gap section and to the LDS at its lower end via a lower gap section. Between the upper gap section and lower gap section is an insulating gap section, an insulating structure that mechanically connects the UDS to the LDS. The ISS spans that insulating gap section and may do so by connecting mechanically directly to the UDS and LDS and not the gap sub (thus mechanically spanning the gap sub) and includes a switch system. That switch system may comprise a switch and electrical connections between the switch system and the LDS and between the switch system and the UDS. The ISS may include the ISC, which ISC can be attached to the gap sub, to the mechanical parts of the switch, or to another part of the tool forming a part of the telemetry system and controls the switch system therefrom. Mechanically, the insulating gap section connects the upper and lower gap sections via threaded connections (drill pipe connections) commonly used in drill pipe and downhole subs to the adjacent elements of the drill string. The upper and lower gap sections are each then connected electrically to the drill pipe via centralizers on those adjacent elements or other methods. The insulating gap section also supports the drill string forces between the upper and lower gap sections. Unlike a traditional gap sub, however, the gap sub and switch system controlled by the ISC can both electrically isolate the UDS from the LDS and readily and controllably form an intentional, low-resistance, or intentionally variable-resistance, electrical connection therebetween. That ISS operates to selectively and variably electrically connect the threaded connections at either end of the gap sub. The ISS requires only low power and may be switched at frequencies in ranges that are selected and useful to the operator. In addition, the switch system, particularly the ISC, can be electronically linked for control purposes to an MWD tool (e.g. a data-source), or other upstring or downstring device requiring data telemetry.

In another embodiment, the telemetry system includes an impedance-variation system, including a gap sub, an impedance switch system (ISS), and an electrical connection between the upper drill string portion and the lower drill string portion. The ISS has an impedance switch controller (ISC) for controlling the electrical connection to provide a selectively controllable and variable electrical connection between the upper drill string portion and lower drill string portion across that gap sub.

In another embodiment, the telemetry system includes an impedance-variation system, including a gap sub, a downhole tool including a gap tool, and electrical connection between the upper drill string portion and the lower drill string portion and the gap tool. The gap tool has an impedance switch system (ISS) with an impedance switch controller (ISC) for controlling that electrical connection to provide a selectively controllable and variable electrical connection between the upper drill string portion and lower drill string portion across that gap sub. The gap tool includes an upper gap section (which can be considered an upper tool gap section), a lower gap section (which can be considered a lower tool gap section), and an insulating section (which can be considered an insulating tool section), where the upper tool gap section is electrically connected to the upper drill string portion at the gap tool's upper end, the lower tool gap section is electrically connected to the lower drill string portion at the gap tool's lower end. Between the upper tool gap section and lower tool gap section is that insulating tool section, an insulating structure that mechanically connects the upper tool gap section and lower tool gap section. The ISS spans that insulating tool section and may do so by connecting mechanically and electrically to the upper tool gap section and lower tool gap section. Mechanically, the gap tool connects an upstring device in the downhole tool at its upper end to a downstring device in the downhole tool at its lower end via typical threaded connections commonly used in downhole tools. The upper and lower tool gap sections are each then connected electrically to the drill pipe via upper and lower centralizers, which may be mounted the upper and lower tool gap sections, respectively, or to the upstring and downstring devices (whose exterior tool skins would be electrically connected to, respectively, to the upper tool gap section and the lower tool gap section). Conversely, upper and lower centralizers could be mounted on the gap sub or drill collars for contact with, respectively, the upper and lower tool gap sections or the upstring and downstring devices. That ISS operates to selectively and variably electrically connect the upper and lower tool gap sections at either end of the gap tool, and the ISC can be electronically linked for control purposes to a downhole tool (e.g. a data-source), or other of the upstring or downstring devices requiring data telemetry.

In another embodiment that varies from the previous one in that there is not a drill pipe separating the tool from the formation, the telemetry system includes an impedance-variation system in a borehole, including a downhole tool including a gap tool, the gap tool making a selectively and variably electrical connection between upstring and downstring devices in the downhole tool. Here, the upper and lower tool gap sections are each then connected electrically (primarily if not entirely) to the formation via the exterior tool strings of the upstring and downstring devices whose exterior tool skins would be electrically connected, respectively, to the upper tool gap section and the lower tool gap section.

The IVS, or gap sub and ISC, or gap sub and gap tool permit a telemetry system with a variable impedance. When the switch system is open, the electrical current from the transmitter travels along the UDS and closes the circuit by propagating through the drilling fluid and the earth before returning to the surface, causing a higher impedance for the system through which the transmitter is transmitting. When the switch system is closed, the electrical current from the transmitter may also travel along a greater surface area (that of the LDS) and also may pass through the connection between the LDS and the earth, and closes the circuit by propagating through the drilling fluid and the earth before returning to the surface, causing a lower impedance for the system through which the transmitter is transmitting. When the switch system has an intermediate resistance, the electrical current from the transmitter may also travel along a greater surface area (that of the LDS), but at a higher resistance than when the switch system is closed, and also may pass through the connection between the LDS and the earth, and closes the circuit by propagating through the drilling fluid and the earth before returning to the surface, causing a lower but intermediate impedance for the system through which the transmitter is transmitting.

A telemetry system with a variable impedance may create high and low measured values (either current or voltage) in the circuit. These two measured values can be viewed as a simply quantized, binary signal. A telemetry system with a variable impedance may create high, intermediate, and low measured values (either current or voltage) in the circuit. These measured values can be viewed as a multiply-quantized signal. A telemetry system with a variable impedance may create continuously-variable measured values that vary between high and low and therebetween (either current or voltage) in the circuit. These measured values can be viewed as a continuously-variable signal. A telemetry system may also use as a controlled value, rather than a constant current/voltage, a known time-varying value of current/voltage. That time-varying value creates a carrier having a known value. An example of such an oscillatory signal is a voltage sine wave. A telemetry system with a carrier having a time-varying controlled value and a variable impedance as input may create measured values (either current or voltage) in the circuit as binary, quantized, simply-quantized, multiply-quantized, or continuously-variable that includes the known value of the carrier. These measured values, whether binary, quantized, simply-quantized, multiply-quantized, and/or continuously-variable are signals and are capable of communicating the input data via known telecommunication/demodulation protocols.

One embodiment of the invention comprises an transmitter located at the surface which applies a controlled, and constant, voltage across two locations at or near the surface, thus causing current to flow into the drill string and the earth. An impedance-variation system with a selectively-electrically insulating gap sub is located in the drill string near its lower extremity, proximal to the MWD tool desiring to send data. The magnitude of the current in the electrical circuit, or conversely the apparent electrical impedance seen by the transmitter, can be modified by selectively electrically shorting the gap sub to allow current to flow past the gap sub and between the LDS and UDS.

When the gap sub is not shorted (and is electrically insulating) by having the switch system in the open state, such as by controlling it by an ISC, the currents travel along the drill string and close the circuit by propagating through the drilling fluid and the earth before returning to the surface. This can be called a lower current value (or conversely a higher impedance value) and the electrical current must travel through the outer and reasonably cylindrical surface of the drill string, through the drilling fluid and then on through the earth.

When the gap sub is shorted (and is electrically conductive) by having the switch system in the closed state, such as by controlling it by an ISC, the currents travel along the drill string, through and past the gap sub. This exposes greater surface area for the electrical current to flow through to complete the electrical circuit, and further adds the connection between the drill bit and the earth. The combination of the addition of extra length and the connection between the drill bit and the earth provides an easier path for the electrical current to flow from the drill string through the drilling fluid and then into the earth and to return to the surface and complete the circuit. This can be called a higher current value (or conversely a lower impedance value).

The change in the electrical current seen in the circuit can be measured at the surface location, and the MWD tool can encode and transmit data to the surface by selectively closing the gap sub as desired to create two distinct magnitude values for the current, and using these two states to transmit data from the subsurface location to the surface.

Another embodiment of the invention comprises an transmitter located at the surface which applies a constant (or controlled) current between two locations at or near the surface, and the apparent impedance seen between these two locations necessarily creates a measurable voltage across these two points. An impedance-variation system with a selectively-electrically insulating gap sub is located in the drill string near its lower extremity, proximal to the MWD tool desiring to send data. The magnitude of the voltage measured across these two points can be modified by selectively electrically shorting the gap sub to allow currents to flow past the gap sub and between the LDS and UDS.

When the gap sub is not shorted (and is electrically insulating) by having the switch system in the open state, such as by controlling it by an ISC, the currents travel along the drill string, and closes the circuit by propagating through the drilling fluid and the earth before returning to the surface. This can be called the higher impedance condition, and the electrical current must travel through the outer and reasonably cylindrical surface of the drill string, through the drilling fluid and then on through the earth. The result of the impedance being at a higher value results in the voltage measure across the two points at the surface to be at a higher value.

When the gap sub is shorted (and is electrically conductive) by having the switch system in the closed state, such as by controlling it by an ISC, the currents travel along the drill string, through and past the gap sub. This exposes greater surface area for the electrical current to flow through to complete the electrical circuit, and further adds the connection between the drill bit and the earth. The combination of the addition of extra length and the connection between the drill bit and the earth provides an easier path for the electrical current to flow from the drill string through the drilling fluid and then into the earth and to return to the surface and complete the circuit. This can be called the lower impedance condition, and the result of the impedance being at a lower state results in the voltage measure across the two points at the surface to be at a lower value.

The change in the voltage measured across the transmitter on the surface can be measured at the surface location, and the MWD tool can encode and transmit data to the surface by selectively closing the gap sub as desired to create two distinct states of voltage magnitude and using these states to transmit data from the subsurface location to the surface.

A transmitter system can also use a time-varying controlled input. Another embodiment of the invention comprises a constant power source coupled to a drill string and a surface conductor at or near the surface and spaced apart therefrom, an electrical measurement system. That transmitter system applies a controlled electrical signal across those two locations, thus causing current to flow into the drill string and the earth. That electrical signal has a constant characteristic (or “controlled value” of either voltage or current, whether a time-varying value such as AC, or DC) and a resultant variable characteristic (or “measured value” of either current or voltage). An IVS is located between and mechanically connecting the LDS to the UDS. The electrical measurement device measures the magnitude of the measured value in the electrical circuit, which reflects the apparent electrical impedance seen by the transmitter system, and provides that data further to the system. The IVS can control that electrical impedance by selectively switching between an insulating state and a conducting state, the latter allowing current to between the LDS and UDS.

When the IVS is in the insulating state by having the switch in the open position, the current travels along the UDS and closes the circuit by propagating through the drilling fluid and the earth before returning to the surface. Here the electrical current must travel through the outer and reasonably cylindrical surface of the drill string, through the drilling fluid and then on through the earth. Here the electrical measurement system will measure a lower value for the measured value, reflecting the higher impedance caused by the IVS being in the insulating state.

When the IVS is in the conducting state by having the switch in the closed position, the current travels along the drill string, through and past the IVS. This exposes greater surface area (of the LDS) for the electrical current to flow through to complete the electrical circuit and also adds the connection between components of the LDS (e.g. the drill bit) and the earth, and the current closes the circuit by propagating through the drilling fluid and the earth before returning to the surface. This provides an easier path for the electrical current to flow from the drill string through the drilling fluid and then into the earth and to return to the surface and complete the circuit. Here the electrical measurement system will measure a higher value for the measured value, reflecting the lower impedance caused by the IVS being in the conducting state

The change in the electrical signal, and in the measured value, seen in the circuit can be measured at the surface location. The MWD tool, using the IVS, can encode and transmit data to the surface by selectively alternating the IVS between the insulating and conducting states to create a pair of distinct magnitude measured values forming a binary signal (i.e. as low & high), and using these two states to transmit data from the subsurface location to the surface.

These are examples of transmitter systems using a constant controlled value that creates a simply-quantized signal, but such a system can also create a multiply-quantized signal or one that is continuously-variable.

Another embodiment of the invention comprises a transmitter located at the surface which applies a constant (or controlled) value (current or voltage) between two locations at or near the surface, and the apparent impedance seen between these two locations necessarily creates a measurable voltage across these two points. An impedance-variation system is located in a drill string having a gap sub and near its lower extremity, or in the downhole tool, and with an impedance switch system (ISS) having an impedance switch controller (ISC). The magnitude of the measured value (voltage if the controlled value is current, or vice-versa) measured across these two points can be modified by selectively controlling and varying the electrical connection across the gap sub to allow controlled and varying amounts of current to flow past the gap sub and between the LDS and UDS.

Here, the ISS can place the gap sub in high, intermediate, and low impedance conditions (or, for example, in highest, higher, higher intermediate, lower intermediate, lower, and lowest impedance conditions) that are quantized, or can place the gap sub in continuously variable impedance conditions varying within a range. Doing so will control the amount of electrical current flowing along the drill string to propagate through the drilling fluid and the earth before returning to the surface, in particular by controlling the amount of electrical current flowing past the gap sub, which exposes greater surface area for the electrical current to flow through to complete the electrical circuit.

The change in the measured value across the transmitter on the surface can be measured at the surface location, and the MWD tool can encode and transmit data to the surface by selectively and variably controlling that electrical connection across the gap sub as desired to create a signal. In this instance, the measured value may include the known value of the carrier where the controlled value is time-varying.

In practice, a variable-impedance telemetry system operates as follows: a power supply is provided at the surface that provides an transmitter with an electrical signal (AC or DC) with a controlled value and a measured value. That electrical signal passes to a conductor mounted at or near the surface and coupled with the earth formation. An electrical measurement system continuously measures the measured value of the transmitter. The impedance of the system is controlled to be discernable using a communications protocol to communicate data from the downhole tool components. An ISS having a switch system electrically spanning a gap sub connecting an LDS and UDS of the drill string is operated by an ISC to controllably vary between or among impedance states which varies the impedance of the system into which the transmitter transmits. That could be between an insulating state and a conducting state (caused respectively by an open switch position and a closed switch position), or among other impedance states such as high, one or more intermediate, and low states, or variable (or continuously-variable) impedance states varying within or along a range. Here, higher impedance states correspond to conditions in which a switch is in a higher impedance position, resulting in a greater impedance between the LDS and UDS (as well as the upper and lower gap sections on either end of the insulating gap section), and lower impedance states correspond to conditions in which a switch is in a lower impedance position, resulting in a lower impedance between the LDS and UDS (as well as the upper and lower gap sections on either end of the insulating gap section). The switch may be controlled by the ISC to cause the switch to be in the impedance position corresponding to that impedance state. This causes the measured value to vary as well, such as between a high value and a low value (in the case of the simply-quantized signal) forming an analog measured value signal, SA. In the case of the simply-quantized signal, SA can be understood as being formed of alternating Sopen (the signal when the switch is open) and Sclosed (the signal when the switch is closed). The system provides that analog measured value signal to a signal discriminator to create a digital binary signal, SB. SB can be understood as being formed of corresponding 0's and 1's. SB is then provided to a data collection device for further use. In the case of multiply-quantized or continuously-variable signals, SA can be understood as being formed of Shi (signal when measured value is higher), one or more Sint (signal when measured value is at an intermediate value), and Slo (signal when measured value is lower). The measured value may be in-phase or out-of-phase with the change in impedance (and the impedance position and state) depending on whether the controlled value is current or voltage. SA is also provided to a signal discriminator or demodulator to extract that signal, which can be provided to a data collection device for further use.

Thus, various options of systems are possible depending upon demands of the environment or data telemetry needs, depending upon the nature of what may be considered as a carrier and the input, and will result in different output to be decoded or demodulated. The surface-provided carrier, comprising the control value (whether V or I), can be either time-invariant (e.g. DC) or time-varying (e.g. AC). The input, created by an impedance-variation system (typically to transmit data from one or downhole tools to the surface), can also be binary, simply-quantized, multiply-quantized, or vary continuously. The output, seen as the measured value (whether I or V) will necessarily vary, and perhaps complexly, but knowledge of the nature of the carrier and how the input is encoding the data will permit recovery of that data.

### BRIEF DESCRIPTION OF THE DRAWINGS

FIG. 1 is a side view of an embodiment of parts of the surface and downhole portions of a drilling rig used with the invention.

FIGS. 2 & 3 are partial side views of an embodiment of the invention in a first and a second state.

FIGS. 4 & 5 are partial side views of another embodiment of the invention in a first and a second state.

FIGS. 6A & 6B are partial cutaway side views of an embodiment of the invention in two different states.

FIGS. 7A & 7B show interrelationships among certain characteristics of two embodiments of the invention.

FIGS. 8A & 8B are partial cutaway side views of embodiments of the invention.

FIGS. 8C-8F show an embodiment of the invention in different states.

FIGS. 9 & 10 are partial side views of another embodiment of the invention in a first and a second state.

FIG. 11 shows interrelationships among certain characteristics of an embodiment of the invention.

FIG. 12 is a side view of an embodiment of parts of downhole portion of an embodiment of the invention.

### DETAILED DESCRIPTION OF THE INVENTION

In one embodiment of the invention, as described in detail below, information of use to the driller is measured at the bottom of the wellbore relatively close to the drill bit by an MWD tool and this information is transmitted to the surface by modulating the electrically conductive state of a gap sub located close or at the MWD tool. The MWD tool may measure at least one parameter, usually an analog signal, and this signal is processed by the MWD tool and readied for transmission to the surface. The MMD tool then causes the gap sub to electrically short or open as needed to transmit the data to the surface, and this data may be encoded into a format that allows the information to be decoded at the surface and the embedded information extracted and displayed.

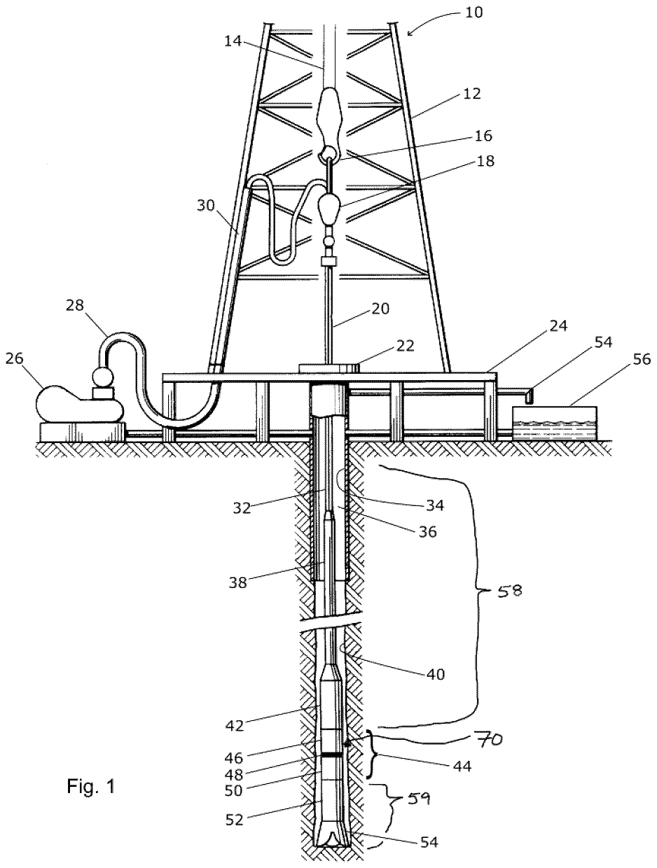

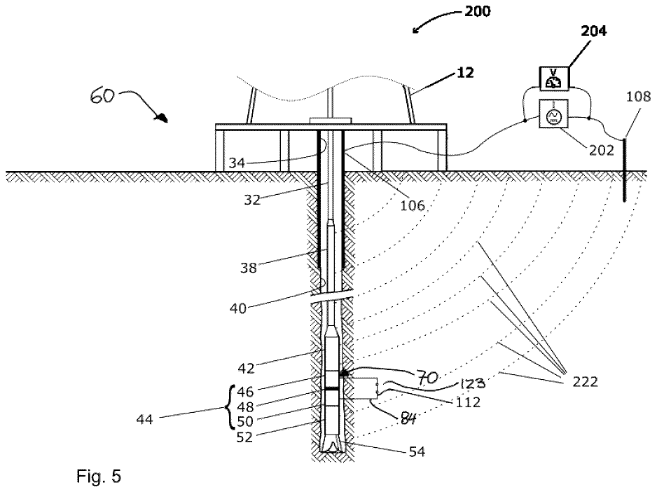

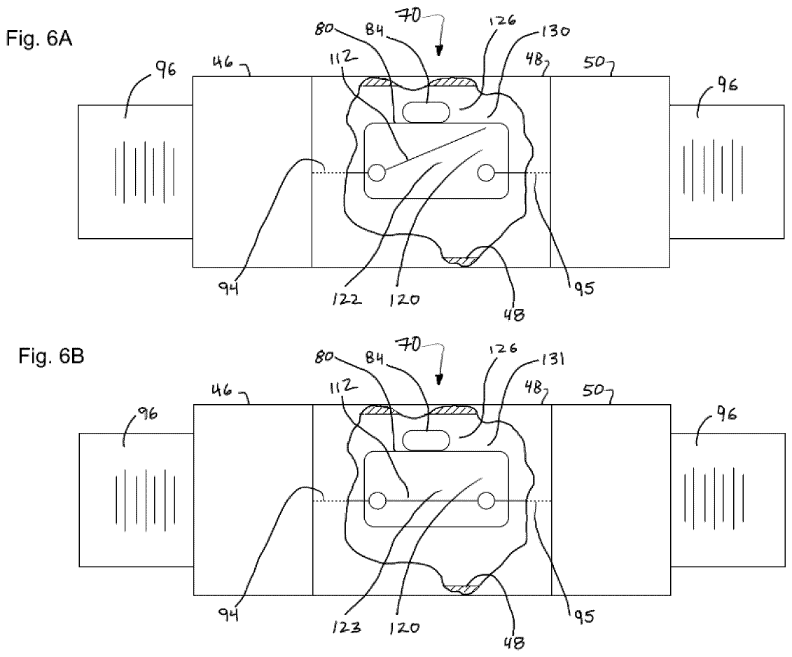

Referring now to the drawings and specifically to FIG. 1, showing telemetry system 60, there is generally shown therein a simplified sketch of the apparatus used in the rotary drilling of boreholes 40. A borehole 40 is drilled into the earth using a rotary drilling rig 10 which consists of a derrick 12, drill floor 24, draw works 14, swivel hook 16, swivel joint 18, Kelly joint 20 and rotary table 22. A drill string 32 used to drill the wellbore is made up of multiple sections of drill pipe that are secured to the bottom of the Kelly joint 20 at the surface and the rotary table 22 is used to rotate the entire drill string 32 while the draw works 14 is used to lower the drill string 32 into the borehole 40 and apply controlled axial compressive loads. A portion of the wellbore 40 near the surface is generally sheathed in a cylindrical pipe called the casing 34 to stiffen the wall of the well bore 40 and to prevent the wellbore 40 from collapsing, and further to prevent the migration of drilling fluids into the earth near the surface. Casing 34 is electrically connected to the drilling rig 10 and may also be connected to other near surface or subsurface equipment such as blow out preventors, rams or other devices as are needed to facilitate the drilling process. The bottom of the drill string 32 is attached to multiple lengths of drill pipe 38, and then subsequently onto drilling collars 42. Drill pipes 38 are generally smaller and thinned in nature and are generally used to add length to the drill string 32, while drilling collars 42 are thicker and heavier in nature and are used to stiffen the bottom of the drill string 32 and add localized weight to the aid in the drilling process. Drill pipes 38 and drilling collars 42 above gap sub 44 is upper drill string section (UDS) 58. A gap sub 44 is inserted below the drill collars 42 (and UDS), said gap sub 44 consisting of an upper gap section 46, a lower gap section 50 and an insulating gap section 48 between upper gap section 46 and lower gap section 50 and mechanically connecting one to the other and selectively electrically connecting one to the other, and forming impedance-variation system 70 (examples in FIGS. 6A & 6B, 8A & 8B). Below the gap subs may reside other drilling components such as drilling motors, stabilizers, rotary steerable systems etc., all labelled collectively here are lower collar section 52. At the bottom extremity of the drilling string 32, a drill bit 54 is attached. Lower collar section 52 and drill bit 54 below gap sub 44 is lower drill string section (LDS) 59.

To aid in the drilling of the wellbore, drilling fluid is usually stored in mud tanks 56, and is sucked up by mud pump 26, which then forces the drilling fluid to flow through a Kelly hose 28, through the standpipe 30 and into the swivel joint 18 and into the inside of the drill string 32. The fluid flows through the drill string 32, first through the drill pipe 38, through the drill collars 38, and further through the gap sub 44, and subsequently through the lower collar section 52, and through fluid flow nozzles in the drilling bit 54. The drilling fluid then returns to the surface by travelling through the annular space 40, then further through the annular space 36. When the fluid reaches the surface, it is diverted to the mud return line 54 back to the mud tanks 56.

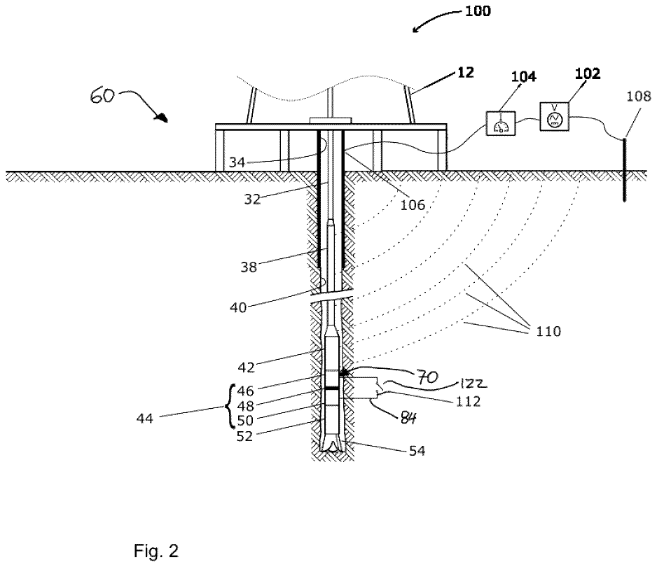

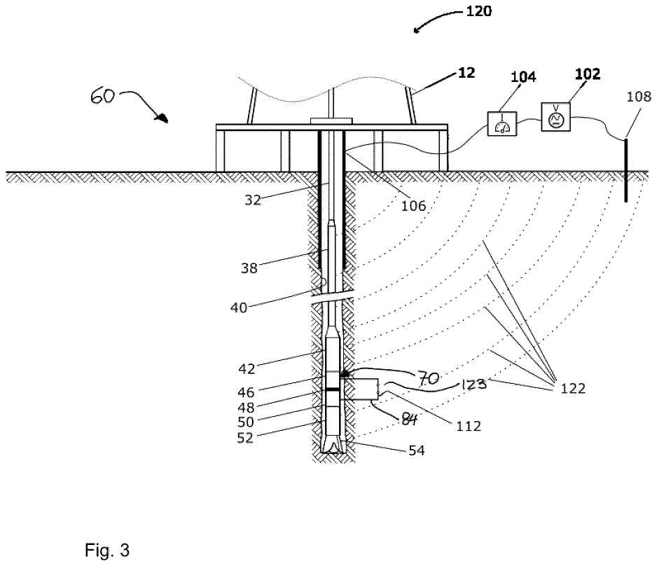

FIG. 2 generally shows therein a simplified sketch of one embodiment of the invention in one of its two impedance states 126, specifically an embodiment of telemetry system 60 using a constant voltage power source and shown in its open state. Derrick 12 is used to suspend drill string 32 with UDS 58 and LDS 59 including components drill pipe 38, drill collars 43, gap sub 44, lower collar section 52 and drill bit 54 into borehole 40. Voltage power supply 102 is located on the surface and is connected on one side through current measurement device 104 to the drilling rig 100 near its substructure at primary location 106, with current measurement device 104 providing data on the measured value of the current. This location may be the casing 34 of the wellbore, or other electrically connected locations that are found at the rig site that are electrically connected to the drill string 32, such as a blowout preventor, rams or other such items. The other side of voltage power supply 102 is connected to a secondary location 108 some distance away from the epicenter of the wellbore 40 and connected to the earth at this location through a surface conductor, here a conductive electrical rod, at secondary location 108. Voltage power supply 102, current measurement device 104, drill string 32, and impedance-variation system 70 form a transmitter.

It will be apparent to those familiar in the art that the separation between the primary location 106 and secondary location 108 for the surface conductor may need to be on the order of hundreds of feet, and that both the locations may include multiple contact points to ensure good conduction of electrical current from the voltage power supply 102 to the two locations. Secondary location 108 may also be placed along the directional path of the wellbore in deviated, directional or horizontal drilling to improve the detection of signals. It will also be apparent to those familiar that the location of current measurement device 104 can be moved to the other side of voltage power supply 102 or located anywhere along the wires and cabling connecting the voltage power supply 102 to either of the two surface locations 106 and 108.

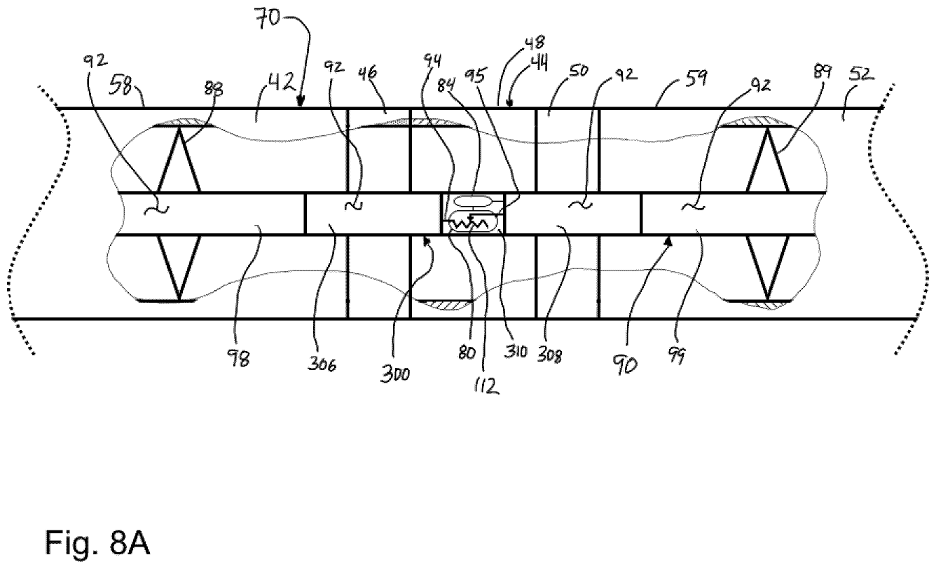

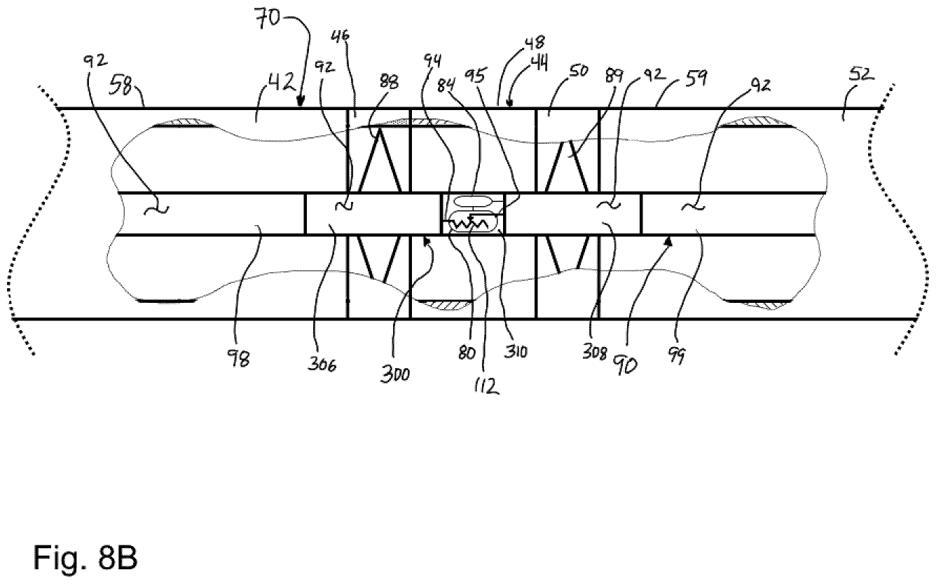

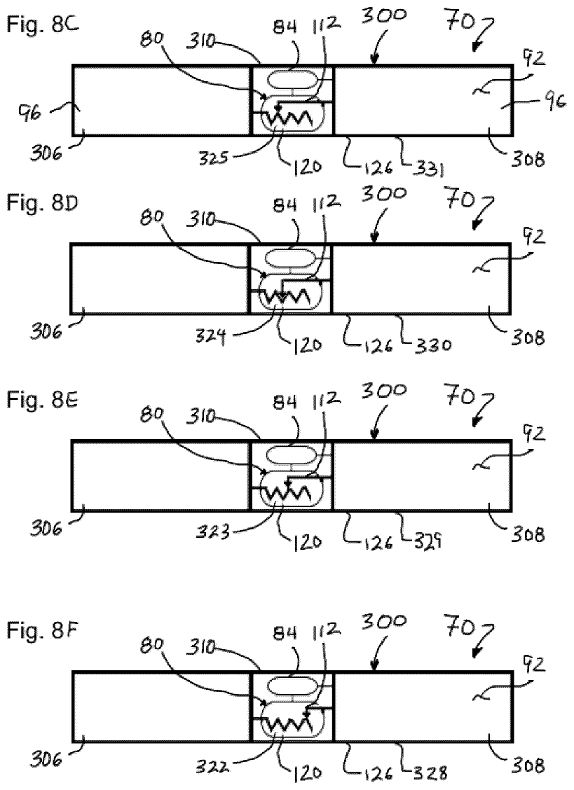

With further reference to FIGS. 6A & 6B, impedance-variation system 70 includes gap sub 44, consisting of upper gap section 46, lower gap section 50, and insulating gap section 48, and impedance switch controller 84, which are shown in stylized form, as is a representative diagram of a switch 112, shown in open position 122 of its two impedance positions 120. Switch 112 may be resident inside the gap sub 44 or may be built into an MWD tool (e.g. FIGS. 8A & 8B) that contacts both the upper gap section 46 and the lower gap section 50 of gap sub 44. Switch 112 is electrically connected at its ends to the upper gap section 46 and lower gap section 50. Switch 112 changes between its two impedance positions when the MWD tool commands that switch 112 activates to either open position 122 or closed position 123 (see FIG. 3), the switch 112 responds by opening or closing electrical connection (upper & lower electrical connections 94 & 95) between the upper gap section 46 and lower gap section 50. Operation of switch 112 between open position 122 and closed position 123 cause impedance variation system, here gap sub 44, to change its insulating state 126, between insulating state 130 and conducting state 131. FIGS. 6A & 6B show the mechanical connections 96 for connecting to the upper drill string 58 and lower drill string 59, which are configured for connecting to downhole components such as drill pipe 38, or drill collars 42, and upper & lower electrical connections 94 & 95.

FIG. 2 & FIG. 6A show the switch 112 in OPEN position 122, thus electrically insulating the upper gap section 46 from the lower gap section 50. Impedance switch system 80 includes switch 112 and impedance switch controller 84, controls its impedance position 120.

Voltage source 102 provides a controlled electrical signal formed of controlled value of voltage, V 550, and measured value of current, I 564, which is variable depending upon the impedance of the circuit, Z. When a voltage V is applied between surface locations 106 and 108 by voltage source 102, a current is induced to flow through current measurement device 104, through UDS 58 of drill string 32, consisting of drill pipe 38, drill collars 42 and then into the upper gap section 46, mechanically and electrically connected to UDS 58 via mechanical connection 96. This current is blocked at the insulating gap section 48 and cannot flow to the lower gap section 50, mechanically and electrically connected to LDS 59 via mechanical connection 96 and the attached items lower collar section 52 and drill bit 54. Here, insulating state 130 corresponds to switch 112 being in its impedance position 120, open position 122, resulting in impedance state 126, insulating state 130, a higher impedance state between upper gap section 46 and lower gap section 50 and thus between UDS 58 and LDS 59. The current therefore completes the electrical circuit by travelling through the outside surface of the drill string 32 and its components sections drill pipe 38, drill collars 42, and through the upper gap section 46, and travelling through any fluid found in borehole 40, and then onto earth and returns to the surface. The return path of the current is a continuum and may be described visually as current flow lines 110, which in a simplified way are used to show lines of current returning to the surface and closing the circuit to the voltage power supply 102 by passing through secondary location 108.

With gap sub 44 in insulating state 130, the magnitude of this current Iopen 566 flowing through the circuit thus described may be stated simply as the controlled value voltage V 550 of the voltage source 102, divided by the apparent observed impedance 504 of the circuit, which in this case can be named as the open impedance Zopen 506, resulting in a simple model using Ohm's law as V=Iopen*Zopen.

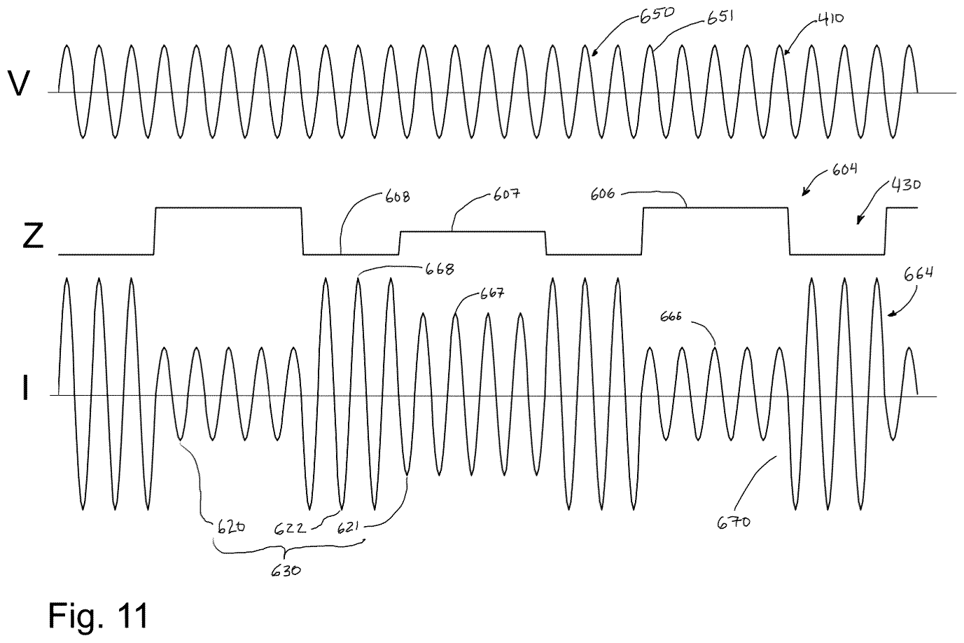

The voltage V 550 can be a DC signal with a fixed value or a time-variant (such as an AC signal which produces a reasonably sinusoidal voltage of both positive and negative magnitude, or an AC signal which produces a reasonably sinusoidal voltage with only positive or negative values). If V is a DC signal, then Iopen 566 will be a DC value. If V is an AC signal, then Iopen will be a reasonably sinusoidal signal whose amplitude at its peak will be equal to Iopen (see FIG. 11).

Some representative values for V 550 may be 100V DC if it is a fixed value, or a 100V AC signal. Zopen 506 may be a number on the order of a few Ohms, or a few tens of Ohms. Using an example of V being a fixed value of 100V and Zopen being equal to 20 Ohms, the value Iopen in this example would be 5 A. If V was an AC signal of peak-peak amplitude 100V (−50V to 50V), and Zopen was a fixed 40 Ohms, then Iopen 566 would be a sinusoid of peak-peak amplitude 2.5 A (−1.25 A to 1.25 A).

FIG. 3 & FIG. 6B show the same embodiment as shown in FIG. 2 & FIG. 6A, except switch 112 is shown in CLOSED position 123 of its two impedance positions 120.

This causes the upper gap section 46 to be electrically connected to lower gap section 50, and thus the LDS to the UDS. When voltage V 550 is applied between surface locations 106 and 108 by voltage source 102, a current Iclosed 568 is induced to flow through current measurement device 104, through the drill string 32, consisting of drill pipe 38, drill collars 42 and then into the upper gap section 46. This current Iclosed 568 travels past the insulating gap section 48 (bypasses insulating gap section 48) and flows to the lower gap section 50 through switch 112 and the attached items lower collar section 52 and drill bit 54. Here, conducting state 131 corresponds to switch 112 being in its impedance position 120, closed position 123, resulting in impedance state 126, conducting state 131, a lower impedance state between upper gap section 46 and lower gap section 50 and thus between UDS 58 and LDS 59. The current completes the electrical circuit by travelling through the outside surface of the drill string 32 and all its component sections including drill pipe 38, drill collars 42, and through the upper gap section 46, lower gap section 50, lower collar section 52 and drill bit 54. Current Iclosed 568 travels through any fluid found in borehole 40, and then onto earth and returns to the surface. The return path of the current is again a continuum and may be described visually as current flow lines 122, which in a simplified way are used to show lines of current returning to the surface and closing the circuit to the voltage power supply 102 by passing through secondary location 108.

Due to the addition of the lower gap section 50, LDS 59, lower collar section 52 and the drill bit 54, the available surface area for current Iclosed 568 to flow from the drill string 32 and its components, through any borehole fluid and onto the earth is increased. In addition, any potential contact made by the drill bit as it contacts borehole 40 further provides additional pathways for the current to enter the earth. The net effect of this is that the current Iclosed 568 has more pathways to return to the surface and as such, the apparent observed impedance 504 which in this case can be named Zclosed 508 will be lower. Consequently, current flow lines 122 are shown to be of greater number than current flow lines 110 (in FIG. 2), however the visual representation is simplified to aid the goal of understandability.

With gap sub 44 in conducting state 131, V=Iclosed*Zclosed. And as Zclosed 508 will be lower than Zopen 506, we can state that Iclosed 568 would be larger than Iopen 566 for a fixed value of V 550. Thus, operating of gap sub 44 permits operating of a transmitter having a controllable and variable impedance.

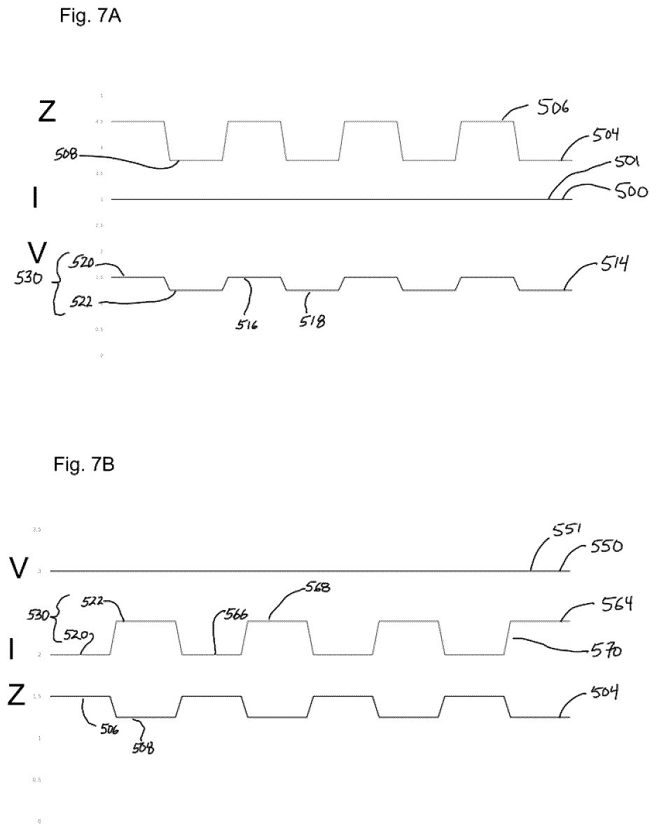

We may summarize and state that the current induced to the flow between the two surface locations 106 and 108 may be switched between the two measured values 564, a high value Iclosed 568 and a lower value Iopen 566, by the means of respectively closing and opening switch 112 to vary the impedance of the system. These two distinct values of current Iclosed and Iopen are measured values measured by current measuring device 104, and these two values may be used to encode data measured by the downhole MWD tool, and then subsequently detected and decoded to provide the data to the driller at surface. FIG. 7B (not to scale with these examples) shows exemplary interrelationships of I, V, & Z.

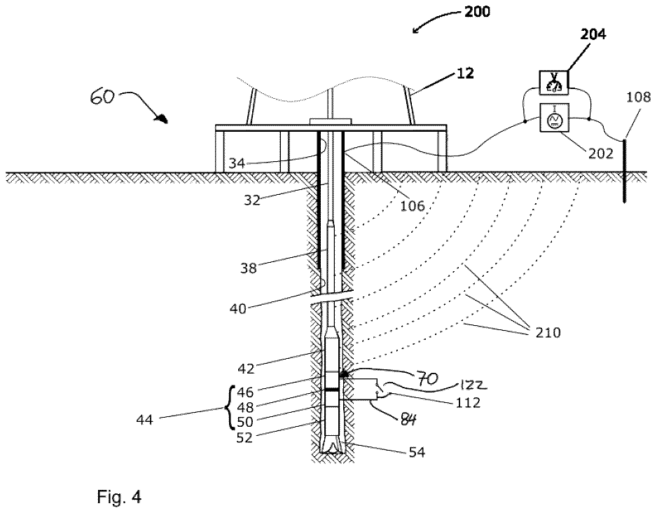

FIG. 4 generally shows therein a simplified sketch of a second embodiment of the invention in one of its two states 126, specifically an embodiment of telemetry system 60 using a constant current power source and shown in its open state. Derrick 12 is used to suspend drill string 32 with UDS 58 and LDS 59 including components drill pipe 38, drill collars 43, gap sub 44, lower collar section 52 and drill bit 54 into borehole 40. Current power supply 202 is located on surface and is connected on one side to the drilling rig 200 near its substructure at primary location 106, with voltage measurement device 204 providing data on the measured value of the voltage. This location may be the casing 34 of the wellbore, or other electrically connected locations that are found at the rig site that are electrically connected to the drill string 32, such as a blowout preventor, rams or other such items. The other side of current power supply 202 is connected to a second location some distance away from the epicenter of the wellbore 40 and connected to the earth at this location through a conductive electrical rod at secondary location 108. Voltage measurement device 204 is used to measure the voltage potential across current power supply 202, or equivalently, across surface locations 106 and 108. Current power supply 202, voltage measurement device 204, drill string 32, and impedance-variation system 70 form a transmitter.

With further reference to FIGS. 6A & 6B, and as described above, impedance-variation system 70 includes gap sub 44, consisting of upper gap section 46, lower gap section 50 and the insulating gap section 48 are shown, as is a representative diagram of switch 112, shown in open position 122 of its two impedance positions 120. Switch 112 is electrically connected at its ends to the upper gap section 46 and lower gap section 50. FIG. 4 shows switch 112 in its OPEN position 122, thus electrically insulating the upper gap section 46 from the lower gap section 50.

Current source 202 provides a controlled electrical signal formed of controlled value of current, I 500, and measured value of voltage, V 514, which is variable depending upon the impedance of the circuit, Z. When a current I is induced to flow between surface locations 106 and 108 by current source 202, the current I is subsequently induced to flow through the UDS 58 of the drill string 32, consisting of drill pipe 38, drill collars 42 and then into the upper gap section 46, mechanically and electrically connected to UDS 58 via mechanical connection 96 This current is blocked at the insulating gap section 48 and cannot flow to the lower gap section 50, mechanically and electrically connected to LDS 59 via mechanical connection 96 and the attached items lower collar section 52 and drill bit 54. Here, insulating state 130 corresponds to switch 112 being in its impedance position 120, open position 122, resulting in impedance state 126, insulating state 130, a higher impedance state between upper gap section 46 and lower gap section 50 and thus between UDS 58 and LDS 59. The current therefore completes the electrical circuit by travelling through the outside surface of the drill string 32 and its components sections drill pipe 38, drill collars 42, and through the upper gap section 46, and travelling through any fluid found in borehole 40, and then onto earth and returns to the surface. The return path of the current is a continuum and may be described visually as current flow lines 210, which in a simplified way are used to show lines of current returning to the surface and closing the circuit to the current power supply 202 by passing through secondary location 108.

With gap sub 44 in insulating state 130, the magnitude of this Voltage Vopen 516 measured across the current power supply 202 may be stated simply as the controlled value current I 500 of the current power supply 202, multiplied by the apparent observed impedance 504 of the circuit, which in this case can be named as the open impedance Zopen 506, resulting in a simple model using Ohm's law as Vopen=I*Zopen.

The current I 500 can be a DC signal with a fixed value or a time-variant (such as an AC signal which produces a reasonably sinusoidal current of both positive and negative magnitude, or an AC signal which produces a reasonably sinusoidal current with only positive or negative values). If I is a DC signal, then Vopen 516 will a DC value. If I is an AC signal, then Vopen 516 will be a reasonably sinusoidal signal whose amplitude at its peak will be equal to Vopen (see FIG. 11).

Some representative values for I 500 may be 1 A DC if it is a fixed value, or a 1 A AC signal. Zopen 506 may be a number on the order of a few Ohms, or a few tens of Ohms. Using an example of I being a fixed value of 1 A and Zopen being equal to 5 Ohms, the value Vopen in this example would be 50V. If I was an AC signal of peak-peak amplitude 0.5 A (−0.25 A to +0.25 A), and Zopen was a fixed 40 Ohms, then Vopen 516 would be a sinusoid of peak-peak amplitude 20V (−1V to 1V).

FIG. 5 & FIG. 6B show the same embodiment as shown in FIG. 4 & FIG. 6A, except switch 112 is shown in CLOSED position 123 of its two impedance positions 120.

This causes the upper gap section 46 to be electrically connected to lower gap section 50. When current I 500 is applied between surface locations 106 and 108 by current source 202, the current I is subsequently induced to flow through the drill string 32, consisting of drill pipe 38, drill collars 42 and then into the upper gap section 46. This current I travels past the insulating gap section 48 and flows to the lower gap section 50 through switch 112 and the attached items lower collar section 52 and drill bit 54. Here, conducting state 131 corresponds to switch 112 being in its impedance position 120, closed position 123, resulting in impedance state 126, conducting state 131, a lower impedance state between upper gap section 46 and lower gap section 50 and thus between UDS 58 and LDS 59. The current I completes the electrical circuit by travelling through the outside surface of the drill string 32 and all its component sections including drill pipe 38, drill collars 42, and through the upper gap section 46, lower gap section 50, lower collar section 52 and drill bit 54. Current I travels through any fluid found in borehole 40, and then onto earth and returns to the surface. The return path of the current is again a continuum and may be described visually as current flow lines 222, which in a simplified way are used to show lines of current returning to the surface and closing the circuit to the current power supply 202 by passing through secondary location 108.

Due to the addition of the lower gap section 50, LDS 59, lower collar section 52 and the drill bit 54, the available surface area for current I to flow from the drill string 32 and its components, through any borehole fluid and onto the earth is increased. In addition, any potential contact made by the drill bit as it contacts borehole 40 further provides additional pathways for the current I to enter the earth. The net effect of this is that the current I has more pathways to return to the surface and as such, the apparent observed impedance 504 which in this case can be named Zclosed 508 will be lower. Consequently, current flow lines 222 are shown to be of greater number than current flow lines 210 (in FIG. 2), however the visual representation is simplified to aid the goal of understandability.

With gap sub 44 in conducting state 131, Vclosed=I*Zclosed. And as Zclosed 508 will be lower than Zopen 506, we can state that Vclosed 518 would be smaller than Vopen 516 for a fixed value of I 500. Thus, operating of gap sub 44 permits operating of a transmitter having a controllable and variable impedance.

We may summarize and state that the current induced to the flow between the two surface locations 106 and 108 causes a voltage potential to develop across the current power supply 202. This voltage potential may be switched between two measured values 514, a high value Vopen 516 and a lower value Vclosed 518, the two measured values, by the means of respectively opening and closing switch 112 to vary the impedance of the system. These two distinct values of current Iclosed and Iopen are measured values measured by voltage measurement device 204, and these two values may be used to encode data measured by the downhole MWD tool, and then subsequently detected and decoded to provide the data to the driller at surface.

FIGS. 7A & 7B (not to scale with these examples) shows exemplary interrelationships of I, V, & Z for a time-invariant controlled value of current or voltage, such as for the embodiments in FIGS. 2, 3, 6A, & 6B, and for the embodiments in FIGS. 4,5, 6A, & 6B, or with the embodiment of FIGS. 8A & 8B. Referring to FIGS. 7A & 7B, the switching of gap sub 44 between its insulating state and its conducting state to vary the impedance of the system causes the measured value to vary between a high value and a low value forming an analog measured value signal, SA. SA can be understood as being formed of alternating Sopen and Sclosed. FIG. 7A shows time-invariant value 501 of controlled value current I 500, with observed impedance 504 varying between a lower Zopen 508 and a higher Zclosed 506. Measured value V 514 consequently varies between a higher Vopen 516 and a lower Vclosed 518. FIG. 7B shows time-invariant value 501 of controlled value current V 550, with observed impedance 504 varying between a lower Zopen 508 and a higher Zclosed 506. Measured value I 564 consequently varies between a lower Iopen 566 and a higher Iclosed 568. Using Ohm's law, the known controlled value V 550/controlled value I 500 and measured values, I 564/V 514, permit derivation of data signal SA 530. These high/low measured values can be recognized as, respectively, Sopen 520 and Sclosed 522, forming SA 530.

Turning to FIGS. 8A & 8B, they show other embodiments of impedance-variation system 70 in partial cutaway. The embodiment in these figures could be used in telemetry system 60 as depicted in FIGS. 2-5, 9, & 10 rather than the embodiment in FIGS. 6A & 6B.

FIGS. 8C-8F show gap tool 300 in isolation in four different impedance states 126 depending upon its impedance position 120. Gap tool 300 comprises upper gap section 306, lower gap section 308, and insulating gap section 310 (which may also be referred to as upper tool gap section, lower tool gap section, and tool insulating section). Gap tool 300 also comprises mechanical connections 96 at the ends of upper gap section 306 and lower gap section 308 for connecting to upstring device 98 & downstring device 99. Gap tool 300 also comprises impedance switch system 80 having impedance positions 120, with switch 112, connected impedance switch controller 84. Switch 112, has more than two settings (i.e. not just open/closed). Rather, switch 112, and thus impedance switch system 80, has high impedance position 322, one or more intermediate impedance positions 323, 324, and lower impedance position 325. These positions need not be discrete, but could be varied in a continuous fashion. Gap tool 300 includes exterior tool skin 92 which is conductive for upper gap section 306 & lower gap section 308 but not for insulating gap section 310. Also included are upper and lower electrical connections 94 & 95 (on FIG. 8A/8B) connecting impedance switch system 80 to upper gap section 306 & lower gap section 308 across insulating gap section 310. Accordingly, varying impedance position 120 changes impedance state 126 for gap tool 300. Here, high impedance state 328 corresponds to switch 112 being in its impedance position 322, intermediate impedance states 329, 330 correspond to switch 112 being in its intermediate impedance states position 323, 324, and lower impedance state 331 corresponds to switch 112 being in its lower position 325. Here, a higher impedance state means there is a higher impedance between upper gap section 46 and lower gap section 50 and thus between UDS 58 and LDS 59.

Returning to FIGS. 8A & 8B, this shows impedance-variation system 70, including gap tool 300, in use in telemetry system 60. FIGS. 8A & 8B show the mechanical connections 96 for connecting to upstring device 98 and downstring device 99, which are configured for connecting to downhole components such as an MWD tool that provides data or requires data

Via mechanical connections 96, gap tool 300 is mechanically connected at upper gap section 306 and lower gap section 308, to upstring device 98 & downstring device 99 and may also be electrically connected thereto including by exterior tool skin 92. Gap sub 44 is shown in partial cutaway to show gap tool 300. Gap sub 44 is connected mechanically and electrically to UDS 58 and LDS 59. In FIG. 8B, an embodiment is shown in which centralizers contact gap sub 44 to electrically connect LDS 59 to UDS 58 thereacross. Upper centralizers 88 are attached to upper gap section 306 of gap tool 300 and contact (and electrically connect) upper gap section 46 of gap sub 44. Lower centralizers 89 are attached to lower gap section 308 of gap tool 300 and contact (and electrically connect) lower gap section 50 of gap sub 44. In FIG. 8A, an embodiment is shown in which centralizers instead directly contact and electrically connect LDS 59 to UDS 58 across gap sub 44. Upper centralizers 88 are attached to upstring device 98 (electrically connected to upper gap section 306 of gap tool 300) and contact (and electrically connect to) UDS 58. Lower centralizers 89 are attached to downstring device 99 (electrically connected to lower gap section 308 of gap tool 300) and contact (and electrically connect to) LDS 59.

As described above in relation to FIGS. 2 & 3, controlling impedance state 126 controls the flow of current through the electrical circuit. At high impedance state 328, less current will reach and pass from UDS 58 and upper gap section 306 through lower gap section 308 and thus LDS 59 and then through any fluid found in borehole 40, and onto earth and returns to the surface. Accordingly, measured value I will be lower. At the intermediate impedance states 329, 330, progressively more current will reach and pass through lower gap section 308 and measured value I will be higher. And at lower impedance state 331, the most current will reach and pass through lower gap section 308 and measured value I will be the highest.

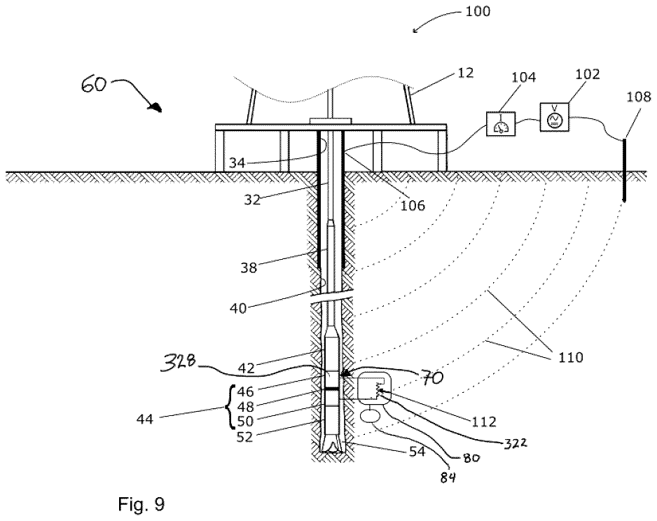

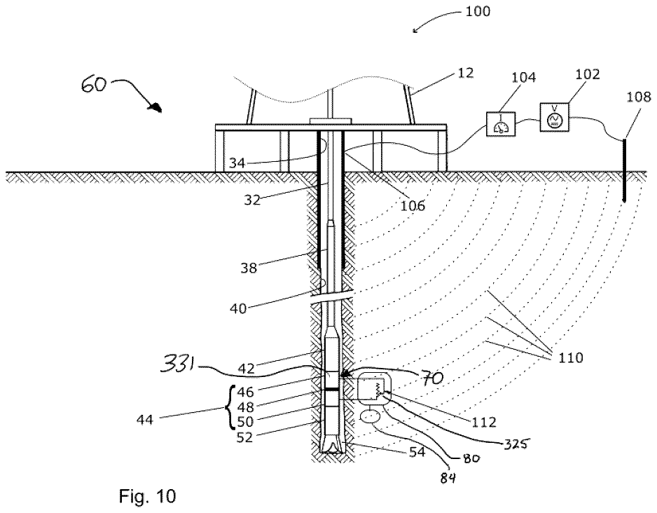

FIGS. 9 & 10 generally show therein a simplified sketch of another embodiment of the invention which is a variation on those shown in FIGS. 2 & 3 (using a controlled value V 550) where similarly labeled components are as discussed above, and reference is made to FIGS. 8A-8F. FIGS. 9 & 10 show telemetry system 60 in two different impedance states 126. Additionally referenced here are impedance switch system 80, included as part of impedance-variation system 70, and switch 112 as part thereof and shown explicitly as including more than two impedance positions 120 (not just open/closed). Rather, switch 112, and thus impedance switch system 80, has high impedance position 322 (shown in FIG. 9), one or more intermediate impedance positions 323, 324, and lower impedance position 325 (shown in FIG. 10) (e.g. as detailed in FIGS. 8A-8F). Impedance state 126 is also referenced, with high impedance state 328 (shown in FIG. 9), intermediate impedance states 329, 330, and lower impedance state 331 (shown in FIG. 10) (e.g. as detailed in FIGS. 8A-8F).

Impedance switch controller 84 commands switch 112 to vary among impedance positions 120 to telemeter data, so that switch 112 chooses among high impedance position 322, one or more intermediate impedance positions 323, 324, and lower impedance position 325, thus altering the electrical connection between upper gap section 306 and lower gap section 308, and thus between upper gap section 46 and lower gap section 50 of gap sub 44. Thus, operation of impedance-variation system 70 alters impedance state 126 among high impedance state 328, intermediate impedance states 329, 330, and lower impedance state 331.

FIGS. 11A & 11B (not to scale with these examples) shows exemplary interrelationships of I, V, & Z for a time-variant controlled value of current or voltage, such as for the embodiments in FIGS. 9, 10, 8A, & 8B, or with the embodiment of FIGS. 6A & 6B. Now, further referring to FIG. 11 is an example where voltage source 102 provides controlled electrical signal formed of a sinusoidal time-varying value 651 as controlled value of voltage V 650 (which may be referred to as carrier 410) and measured value of current, I 664, and the data input (430) from impedance-variation system 70 is reflected in the observed impedance 604, and is multiply-quantized as high impedance 606, intermediate impedance 607, and low impedance 608. Measured value of current I 664 varies sinusoidally due to the nature of controlled value V 650, but also in amplitude due to the variation in observed impedance 604, and consequently varies among a lower Ilo 666, an intermediate Iint 667, and a higher Ihi 668. Using Ohm's law, the known controlled value V 650, even as time-varying, and measured value of current I 664, permit forming derivation of signal 630, formed of Shi 620 (signal when switch 112 is at a lower impedance position), Sint (signal when switch 112 is at an intermediate impedance position), and Slo (signal when switch 112 is at a higher impedance position). Note that data signal 630 for the telemetered data is formed independently of whether the transmitted electrical signal is received. Naturally, the example in FIGS. 9-11 could apply a controlled value of voltage, resulting in a system similar to that shown in FIGS. 4 & 5.

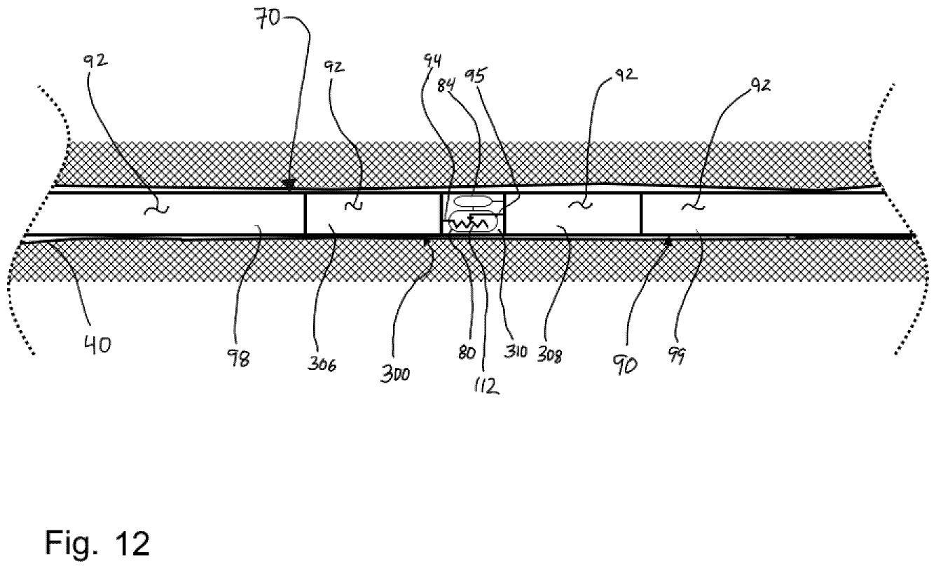

FIG. 12, and further referring to FIGS. 8C-8F, shows an embodiment of impedance-variation system 70 in a downhole environment in borehole 40 without drill string 32 as a part of transmitter for telemetry system 60. Here a power supply (for controlled voltage or current) is located on the surface is connected to downhole tool 90 with a measurement device (to measure current or voltage), with the other side of the power supply connected to a second location some distance away from the epicenter of wellbore 40 and connected to the earth at this second location (reference here is made to FIGS. 2-5 for more details). Downhole tool 90 comprises upstring device 98, electrically connected to the power supply, gap tool 300 mechanically and electrically connected downhole of upstring device 98, and downstring device mechanically and electrically connected downstring of gap tool 300. Exterior tool skin of upstring device 98, downstring device 99, and upper gap section 306 and lower gap section 308 of gap tool 300 are in electrical contact with borehole 40 and thus the surrounding earth/formation.

Controlling impedance state 126 controls the flow of current through the electrical circuit. At high impedance state 328, less current will reach and pass from upstring device 98 and upper gap section 306 through lower gap section 308 and thus downstring device 99 and then through any fluid found in borehole 40, and onto earth and return to the surface. Accordingly, measured value I will be lower. At the intermediate impedance states 329, 330, progressively more current will reach and pass through lower gap section 308 and measured value I will be higher. And at lower impedance state 331, the most current will reach and pass through lower gap section 308 and measured value I will be the highest.

1. An impedance-variation system, for use with a downhole environment having an uphole direction and a downhole direction and with downhole drilling system components, comprising:
an upper gap section comprising a first mechanical connection for downhole drilling system components in an uphole direction;
a lower gap section comprising a second mechanical connection for downhole drilling system components in a downhole direction;
an insulating gap section;
the insulating gap section mechanically connecting the upper gap section to the lower gap section; and
the insulating gap section electrically insulating the upper gap section from the lower gap section; and
an impedance switch system, comprising a switch;
the switch electrically connected between the upper gap section and the lower gap section; and
the impedance switch system having at least two impedance positions, including a high impedance position and a low impedance position.

2. The system of claim 1, further comprising:
the impedance-variation system having at least a high impedance state and a low impedance state; and
the impedance-variation system having a lower impedance between the lower gap section and the upper gap section in the lower impedance state than in the higher impedance state.

3. The system of claim 1:
the impedance switch system further comprising one or more intermediate impedance positions between the high impedance position and the low impedance position; and
the impedance-variation system further comprising one or more intermediate impedance states between the high impedance state and the low impedance state.

4. The system of claim 1:
the impedance-variation system being selectively controllable between the high impedance state and the low impedance state.

5. The system of claim 4:
the impedance switch system further comprising an impedance switch controller controlling in which of the at least two impedance positions the impedance switch system is placed.

6. The system of claim 4:
the switch being selected from the group consisting of a mechanical contact switch, a magnetically activated relay, a MOSFET, a potentiometer, a variable resistor, and a digital resistor.

7. The system of claim 1:
the first mechanical connection configured for connecting to an upstring device; and
the second mechanical connection configured for connecting to a downstring device.

8. The system of claim 7:
the lower gap section, the lower gap section, and the insulating gap section forming a gap tool.

9. The system of claim 1:
the first mechanical connection comprising a drill pipe connection; and
the lower gap section, the lower gap section, and the insulating gap section forming a gap sub.

10. An transmitter for a downhole telemetry system for operation in an environment having an uphole direction and a downhole direction, comprising:
a drilling string, comprising;
an uphole portion;
a downhole portion; and
an impedance-variation system,
the impedance-variation system comprising at least a high impedance state and a low impedance state; and
the impedance-variation system forming a lower impedance between the uphole portion and the downhole portion in the lower impedance state than in the higher impedance state.

11. The transmitter of claim 10, further comprising:
a surface conductor;
a power source configured to provide an electrical controlled value and an electrical measured value;
the power source electrically connected between the uphole portion and the surface conductor.

12. The transmitter of claim 11, further comprising:
the measured value being current; and
the controlled value being voltage.

13. The transmitter of claim 10, further comprising:
the impedance-variation system being selectively controllable between the high impedance state and the low impedance state.

14. The transmitter of claim 10:
the impedance-variation system further comprising an impedance switch system comprising a switch;
the switch electrically connected between the uphole portion and the downhole portion.

15. The transmitter of claim 14:
the impedance switch system
further comprising at least two impedance positions, including a high impedance position and a low impedance position; and
an impedance switch controller controlling in which of the at least two impedance positions the impedance switch system is placed.

16. The transmitter of claim 14:
the impedance switch system further comprising a high impedance position, a low impedance position, and one or more intermediate impedance positions between the high impedance position and the low impedance position; and
the impedance-variation system further comprising one or more intermediate impedance states between the high impedance state and the low impedance state.

17. The transmitter of claim 10:
the impedance-variation system further comprising
an upper gap section comprising a mechanical connection to the uphole portion;
a lower gap section comprising a mechanical connection to the downhole portion; and
an insulating gap section between the upper gap section and the lower gap section;
wherein the impedance-variation system is mechanically connected between the downhole portion and the uphole portion.

18. The transmitter of claim 10:
further comprising an upstring device and a downstring device;
at least one of said upstring device and said downstring device connected to an interior of at least one of said uphole portion and said downhole portion;
the impedance-variation system further comprising:
an upper gap section comprising a mechanical connection to the upstring device;
a lower gap section comprising a mechanical connection to the downstring device; and
an insulating gap section between the upper gap section and the lower gap section.

19. The transmitter of claim 10, further comprising:
a power source configured to provide an electrical controlled value and an electrical measured value;
the controlled value being a time-varying value.

20. A method of telemetering data in a downhole environment having an uphole direction and a downhole direction in a downhole formation, comprising:
transmitting an electrical signal into a drill string, wherein the drill string and the downhole formation form an electrical circuit;
controllably varying the impedance of the drill string; and
measuring a measured value of the electrical signal.

21. The method of claim 20:
the transmitting step comprising controlling one value of the electrical signal.

22. The method of claim 21:
the controlling step comprising providing a time-varying value.

23. The method of claim 20:
the varying step comprising selectively controlling an impedance-variation system in the drill string between at least a high impedance state and a low impedance state.

24. The method of claim 23:
the selectively controlling step comprising operating a switch electrically connected across an insulating gap section in the drill string.

25. The method of claim 24:
the operating step comprising creating a lower impedance between an uphole portion of the drill string and a downhole portion of the drill string in the lower impedance state than in the higher impedance state.

26. The method of claim 20:
the measured value comprising at least a low measured value and a high measured value;
the measuring step comprising detecting the low measured value and the high measured value; and
forming a signal using the low measured value and the high measured value.

27. The method of claim 26:
the measured value further comprising one or more intermediate measured values between the low measured value and the high measured value;
the measuring step further comprising detecting the one or more intermediate measured values; and
the forming step further comprising forming the signal using the low measured value, the high measured value, and the one or more intermediate measured values.

28. The method of claim 26:
the forming step independent of receiving the electrical signal.

29. The method of claim 20, further comprising:
the controllably varying step comprising controlling the impedance-variation system among at least a high impedance state and a low impedance state, and one or more intermediate impedance states therebetween.
